(19) United States
(12) Patent Application Publication
(10) Pub. No.: US 2018/0112419 A1
(43) Pub. Date: Apr. 26, 2018

(54) TRUCK MOUNTED CARGO BOX, KIT, SYSTEM, AND METHOD FOR INSTALLING LOOSEFILL BLOWN INSULATION

(71) Applicant: 2524692 Ontario Inc., Burlington (CA)

(72) Inventors: Timothy D. Zabransky, Burlington (CA); Evan Douglas Michael Skrepnek, Kleinburg (CA)

(73) Assignee: 2524692 Ontario Inc., Burlington (CA)

(21) Appl. No.: 15/792,018

(22) Filed: Oct. 24, 2017

Related U.S. Application Data
(60) Provisional application No. 62/411,740, filed on Oct. 24, 2016.

(51) Int. Cl. E04F 21/08; B62D 65/00; E04B 1/76

(52) U.S. Cl. CPC E04F 21/085; E04B 1/7604; B62D 65/00

(57) ABSTRACT

A truck-mounted cargo box houses a commercial-grade system for blowing loosefill insulation material in bags through a hose, without first removing insulation from the bags. The cargo box and system include bag feeding means, and a chute having an inlet end positioned in an end wall of the cargo box mounted on the truck. Also included is a material processing unit in the form of a wood-chipper style or other industrial and/or commercial grade shredder, for together shredding the bags and the insulation material, without first removing the insulation material from the bags, and conditioning them both, as a composite material, to be fed into a fluid stream through the hose. There is also disclosed a kit for retrofitting a cargo box, and a related method.

### FIELD OF THE INVENTION

The invention relates generally to the field of installing loosefill blown insulation and, more particularly, to a truck-mounted cargo box, kit, system, and method for installing loosefill blown insulation.

### BACKGROUND OF THE INVENTION

In the insulation of buildings, a frequently used insulation product is loosefill insulation. In contrast to the unitary or monolithic structure of insulation batts or blankets, loosefill insulation is comprised of a multiplicity of discrete, individual tufts, cubes, flakes or nodules. Loosefill insulation is usually applied to buildings by blowing the insulation into an insulation cavity, such as an attic or wall cavity of a building. Typically, loosefill insulation is made of glass fibers or cellulose fibers. Loosefill insulation is commonly referred to as “blowing wool” and is typically compressed and packaged in plastic bags for transport from an insulation manufacturing site to a building that is to be insulated. Typically these bags are made of polypropylene, polyethylene, or other suitable material. During the packaging of the blowing wool, it is placed under compression for storage and transportation efficiencies. Typically, the blowing wool is packaged with a compression ratio of at least about 5:1.

The distribution of blowing wool into an insulation cavity of a building typically uses a blowing wool distribution machine that feeds the blowing wool pneumatically through a distribution hose, whose free end is manipulated during operation by an installer situated adjacent to the building cavity.

Generally speaking, there are two main categories of blowing wool distribution machines: (1) robust, large-scale commercial-grade machines, which offer high wool-shredding throughput and are intended for regular usage by professional insulation contractors; and (2) small-scale lightweight do-it-yourself (“DIY”) style machines, which are typically offered for short-term rental by equipment rental, building centres, and/or hardware stores on a “one-off” basis to home-owners and to small part-time remodeling and renovation subcontractors. These lightweight DIY machines must be operated by two people, both wearing appropriate safety gear. A first one of the home-owners or part-time subcontractors must stand adjacent the machine and gradually feed insulation material into the machine.

A separate add-on for one such lightweight DIY machine was disclosed in U.S. Pat. No. 8,038,085 which issued on 18 Oct.2011 to O'Leary (the '085 patent), and which provided for a bag digester to receive empty loosefill insulation bags. This lightweight DIY machine and bag digester were disclosed as being specifically adapted for use with specially-designed bags that might be provided with one or more thermally reflective portions. With this invention, a first one of the home-owners or part-time subcontractors (beside the machine) might hold onto the specially-designed bag while gradually feeding the insulation therefrom into the machine, and then separately feed the bag into a separate opening on this lightweight DIY machine, whereupon the bag digester might shred the bag into short strips—i.e., separately from the insulation. The '085 patent suggested that the bag strips then might be recombined with the insulation and, together, agitated within this lightweight DIY machine. Notably, the '085 patent did not disclose any system for together shredding the bags and the loosefill insulation material therein, i.e., without first removing the insulation from the bag, or vice-versa.

Typically, lightweight DIY machines (including the one disclosed in the '085 patent and innumerable others which fail to provide for any shredding whatsoever of bags, i.e., with or without any thermally reflective bag portions) require a second one of the home-owners or part-time subcontractors to, at the same time and wearing all of the appropriate safety gear, be situated in, or adjacent to, the home's attic or wall cavity, where they might be separately responsible for manipulating the free end of the distribution hose and installing the insulation there.

Lightweight DIY machines are neither sufficiently robust, nor do they afford sufficient throughput, to be suitable for use on an ongoing or full-time commercial scale.

Both lightweight DIY machines and commercial-grade blowing wool distribution machines have typically failed, among other things, to provide any automated means for mechanically feeding full bags of loosefill insulation to a shredder on a continuous basis and, as such, have typically required two-people, being one at the shredding machine to open the bags and empty the contents into the machine and one at the free end of the distribution hose to install the loosefill insulation into the attic or wall cavity.

Commercial-grade blowing wool distribution machines intended for regular usage by professional insulation contractors (as opposed to those intended for use by homeowners and do-it yourselfers) are typically large and robust, and can weigh several thousand pounds. They typically have a large vertically directed chute or hopper for accepting and feeding the blowing wool after the bag is opened and the blowing wool is emptied from the bags into the hopper. First, an operator situated adjacent the machine may don the appropriate safety garb and open a bag of loosefill insulation material, before emptying it into the hopper. The bags of loosefill insulation material must be individually opened by the machine operator, and care must be taken by such operator to ensure that the bags do not fall into the hopper and become entrained into the material flow with the blowing wool. Typically these larger machines are separately powered by their own gasoline or diesel engines, although PTO and electrically powered versions are also available. A representative version of a large-scale commercial-grade blowing wool distribution machine is manufactured and available from Krendl Machine Company, of Delphos, Ohio, USA, under its Model #5200. Allowing a bag to fall into the hopper and become entrained into the material flow with the blowing wool could cause potential damage to a commercial-grade blowing machine, with concomitant additional expense and project delays while the machine is shut down and large fragments of the bag material entwined within the mechanisms of the blowing machine are removed and the mechanism is inspected and any damage thereto is repaired.

Common elements of commercial-grade blowing wool distribution machines include: a hopper with an extension for accepting and holding, in its uncompressed state, a supply of the blowing wool emptied from bags into the hopper; an agitator unit which assists in providing a constant flow of the blowing wool into the machine, and in initial decompressing and conditioning of the insulation material; a shredder unit, which also assists in providing material flow through the machine to the next stage, and in ensuring uniform consistency by reducing clumps in the blowing wool; an airlock which traps air and blowing wool while providing a metered material flow; and a blower unit which provides a positive air flow to move the blowing wool from the airlock to the delivery hose.

Heavy duty commercial blowing wool distribution machines are typically permanently mounted for transport to and from work sites and for usage at such sites in an enclosed cargo box of a truck or trailer. In this manner, frequent lifting of the machines is eliminated, and the machines are better sheltered from vandalism and the elements. Moreover, the cargo box of the truck or trailer is also useful in transporting a plurality of bags containing the blowing wool to jobsites and in storage of same.

Emptying of the bags of compressed blowing wool into the hopper is not only strenuous, tedious, and time consuming for the blowing machine operator, but also represents a potential health hazard by way of ingestion of airborne insulation particles by the machine operator, and by way of the possibility of injury to the operator coming into contact with rotating drums and blades of the feed mechanism of the blowing machine during its operation. Injury to the operator is also possible by accidental injury arising from the use of knives or other sharp cutting implements to open the bags of compressed blowing wool prior to emptying their contents into the hopper.

It might be advantageous if a loosefill insulation blowing machines could be used without the need of a separate machine operator who otherwise may be required to continuously feed the hopper of the machine with expanded blowing wool emptied from the bags in which it is shipped, and/or to count the bags or otherwise measure the loosefill insulation material fed into the hopper of the machine and blown into the insulation cavity.

U.S. Pat. No. 7,341,416 issued on 11 Mar. 2008 to Rubtsov (the '416 patent), and disclosed a machine mounted in the cargo-box of a truck and a method to feed filled insulation bags, open the bags, empty the insulation from the bags, and dispose of the empty bags. That is, according to the '416 patent, powered wheels drive bags filled with insulation towards knives which slit them open, before removing the empty plastic bags from the insulation. The insulation is then fed, on its own, into a thrasher before being blown using a distribution hose. That is, the insulation is removed from the bags before blowing it. Among other things, the '416 patent does not appear to disclose (i) any means to remote from the truck, e.g., from the free end of the distribution hose, count the bags or otherwise measure the loosefill insulation material fed into the machine and blown into the insulation cavity, (ii) a material processing unit adapted to shred or deliver the bags, together with the insulation released therefrom, as a composite material of a desired density/consistency into the airstream of the hose, or (iii) a separately ventilated enclosure to house and cleanly seal away sensitive components from exposure to the loosefill insulation material.

In prior art wool blowing machines (such as, for example, the one disclosed in the '416 patent and many others), kicked up airborne insulation particles may have contaminated or adhered to various working or moving parts or other sensitive components of such machines, thus requiring their frequent servicing and cleaning. It may be advantageous if the working or moving parts or other sensitive components of a loosefill insulation blowing machine could be separately ventilated and/or cleanly sealed away from exposure to the loosefill insulation material.

All of the prior art may suffer from one or more shortcomings and/or disadvantages which may preferably be readily appreciable by and/or suggested to those skilled in the art in view of the teachings and/or disclosures hereof.

It is an object of the present invention to obviate or mitigate one or more disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there is disclosed a commercial-grade system (40), housed in a cargo box (24) mounted on a truck (20) or a trailer (22), for blowing loosefill insulation material in bags (30) through a hose (32), without first removing the insulation material from the bags (30). The commercial-grade system (40) includes a chute (60), bag feeding means (50) and a material processing unit (70). The chute (60) has an inlet end (62) positioned in an end wall (26) of the cargo box (24) mounted on the truck (20). The bag feeding means (50) is associated with the cargo box (24) for mechanically moving the bags (30) located within the cargo box (24) to the inlet end (62) of the chute (60) on a continuous basis. The material processing unit (70) is in the form of a wood-chipper style or other industrial/commercial grade shredder (72), for together shredding the bags (30) and the insulation material, without first removing the insulation material from the bags (30), and conditioning them both, as a composite material, to be fed into a fluid stream (“B”) through the hose (32).

According to the invention, there is also disclosed a commercial-grade system (40) in a cargo box (24) mounted on a truck (20) or a trailer (22). The cargo box (24) has first and second opposed end walls (26, 28). The commercial-grade system (40) is for blowing loosefill insulation material in bags (30) located within the cargo box (24) through a hose (32) without first removing said insulation from said bag (30). The system (40) includes a floor surface (42), a chute (60), bag feeding means (50), and a material processing unit (70). The floor surface (42) extends between the first and second end walls (26, 28) in substantially transverse relation to thereby define a longitudinal axis (“A”). The chute (60) has an inlet end (62) and outlet end (64). The inlet end (62) is positioned in the first end wall (26) and dimensioned and otherwise adapted to accept the bags (30) from the cargo box (24) for directing same through the first end wall (26) to the material processing unit (70). The bag feeding means (50) is associated with the cargo box (24) for mechanically moving the bags (30) located within the cargo box (24) to the inlet end (62) of the chute (60) on a continuous basis. The material processing unit (70) is adapted to receive the bags of loosefill insulation material (30) from the intake chute (62). It includes, as a first processing stage (72) positioned adjacent to the outlet end (64) of the chute (60) in receiving relation thereto, a wood-chipper style apparatus (72) or other industrial/commercial grade shredder, for together shredding the bags (30) and the insulation material into fine particles, i.e., without first removing the insulation material from the bags (30), and without mechanical failure or interruption attributable to the aforesaid shredding of the bags (30). The material processing unit (70) is further adapted to condition them both—i.e., the shredded bags (30) and the loosefill insulation material released from the bags (30) during the aforesaid shredding—as a composite material of substantially uniform consistency, to a desired density. The material processing unit (70) is further configured to feed and deliver the composite material into a fluid stream (“B”) in fluid communication with the hose (32).

According to an aspect of the invention, the bag feeding means (50) includes a dump-style lifting apparatus (50a) operatively connected to the cargo box (24). The second end (28) of the cargo box (24) is thereby lifted higher than the first end (26) of the cargo box (24) so as to move the bags (30) towards the inlet end (62) of the chute (60) under the influence of gravity.

According to an aspect of the invention, the bag feeding means (50) includes a moving floor apparatus or a conveyor belt (50b). An example of a prior art moving floor apparatus may be seen in a short video entitled “Naczepa ruchoma podloga BODEX z hydrauliczną windą zaladowczą” (which may be translated as “Moving floor trailer BODEX with hydraulic lift loading” and) which appears to have been published on 9 Aug. 2014 by Bodex (a manufacturer of semi-trailers located in Szczerców, Poland) and is accessible online, as of July 2016, via the following uniform resource locator (URL): https://www.youtube.com/watch?v=ovTMGbcGcIg.

According to an aspect of the invention, the bag feeding means (50) includes a ram mechanism (50c) that slides along the longitudinal axis (“A”) in generally parallel relation to the floor surface (42), from a starting positon (FIG. 4A) adjacent the second end wall (28) to a final position (FIG. 4C) adjacent the first end wall (26), so as to push the bags (30) stacked on the floor (42) of the cargo box (24) towards the inlet end (62) of the chute (60).

According to an aspect of the invention, the commercial-grade system (40) also includes guide members (44) mounted on the floor surface (42) adjacent the first end wall (26) in skewed relation to the longitudinal axis (“A”) to assist in guiding the bag members (30) towards the inlet end (62) of the chute (60).

According to an aspect of the invention, the material processing unit (70) also includes a second stage (74) and a blower unit (76). The second stage (74) further processes the composite material, before it reaches the blower unit (76). The blower unit (76) feeds and delivers the composite material into the fluid stream (“B”) in fluid communication with the hose (32) as aforesaid.

According to an aspect of the invention, the commercial-grade system (40) also includes a loosefill insulation measuring means (80). The loosefill insulation measuring means (80) is associated with the bag feeding means (50), the chute (60), the material processing unit (70), and/or the hose (32). The loosefill insulation measuring means (80) is for measuring the number of bags (30) of loosefill insulation material, and/or a volume of insulation from the bags (30), located within the cargo box (24) which are blown through the hose (32).

According to an aspect of the invention, one or more working/moving parts of the system (40), and/or other sensitive components of the system (40), are housed in a separate enclosure (90) of the system (40). The enclosure (90) is separately ventilated and/or cleanly sealed away from exposure to the loosefill insulation material.

According to the invention, there is also disclosed a kit for retrofitting a cargo box (24) with the aforesaid commercial-grade system (40). The cargo box (24) is adapted to be mounted on a truck (20) or a trailer (22).

According to the invention, there is also disclosed a method of using the aforesaid kit to retrofit a cargo box (24) with the aforesaid commercial-grade system (40).

According to the invention, there is also disclosed a cargo box (24) mounted on a truck (20) or a trailer (22) for use with bags filled with loosefill insulation material located within the cargo box (24). The cargo box (24) includes an end wall (26) and the aforesaid commercial-grade system (40) for blowing the loosefill insulation material in the bags (30) through a hose (32), without first removing the insulation material from the bags (30).

According to the invention, there is also disclosed a cargo box (24) mounted on a truck (20) or a trailer (22) for use with bags filled with loosefill insulation material located within the cargo box (24). The cargo box (24) includes first and second opposed end walls (26, 28), and the aforesaid commercial-grade system (40) for blowing said loosefill insulation material in said bags (30) through a hose (32) without first removing said insulation from said bag (30).

According to the invention, there is also disclosed a commercial-grade method for blowing loosefill insulation material in bags (30) through a hose (32), without first removing the insulation material from the bags (30). The bags (30) are located within a cargo box (24) that is mounted on a truck (20) or a trailer (22). The commercial-grade method includes a bag feeding step and a material processing step. In the bag feeding step, bag feeding means (50) associated with the cargo box (24) is used to mechanically move, on a continuous basis, the bags (30) located within the cargo box (24) to an inlet end (62) of a chute (60) positioned in an end wall (26) of the cargo box (24). In the material processing step, a material processing unit (70), in the form of a wood-chipper style or other industrial/commercial grade shredder (72), is used to together shred the bags (30) and the insulation material exiting from an outlet end (64) of the chute, without first removing the insulation material from the bags (30), and conditioning them both, as a composite material, to be fed into a fluid stream (“B”) through the hose (32).

According to the invention, there is also disclosed a commercial-grade method for blowing loosefill insulation material in bags (30) through a hose (32), without first removing the insulation material from the bags (30). The bags (30) are located within a cargo box (24) that is mounted on a truck (20) or a trailer (22). The commercial-grade method includes a bag feeding step, a bag directing step, and a material processing step. In the bag feeding step, bag feeding means (50) associated with the cargo box (24) is used to mechanically move, on a continuous basis, the bags (30) located within the cargo box (24) to an inlet end (62) of a chute (60). In the bag feeding step, the inlet end (62) is positioned in a first end wall (26) of the cargo box (24) and is dimensioned and otherwise adapted to accept the bags (30) from the cargo box (24) through the first end wall (26). In the bag directing step, the chute (60) is used to direct the bags (30), received from the cargo box (24) through the first end wall (26), to an outlet end (64) of the chute (60) and towards a material processing unit (70). In the material processing step, the material processing unit (70) is used to receive the bags of loosefill insulation material (30) from the outlet end (64) of the chute (62). The material processing step includes a first processing stage, wherein a wood-chipper style apparatus (72) or other industrial/commercial grade shredder of the material processing unit (70) is positioned adjacent to the outlet end (64) of the chute (60) in receiving relation thereto, and is used to together shred the bags (30) and the insulation material into fine particles, i.e., without first removing the insulation material from the bags (30), and without mechanical failure or interruption attributable to said shredding of the bags (30). In the material processing step, the material processing unit (70) additionally conditions both the shredded bags (30) and the loosefill insulation material released from the bags (30) during the aforesaid shredding, as a composite material of substantially uniform consistency, to a desired density. In the material processing step, the material processing unit (70) additionally feeds and delivers the composite material into a fluid stream (“B”) in fluid communication with the hose (32).

According to an aspect of the invention, in the bag feeding step, a dump-style lifting apparatus (50a) of the bag feeding means (50) is operatively connected to the cargo box (24) and used to mechanically lift a second end (28) of the cargo box (24) higher than the first end (26). The second end (28) is longitudinally opposed to the first end (26) of the cargo box (24). In this manner, the bags (30) are moved towards the inlet end (62) of the chute (60) under the influence of gravity.

According to an aspect of the invention, in the bag feeding step, a moving floor apparatus or a conveyor belt (50b) of the bag feeding means (50) is associated with the cargo box (24) and used to mechanically move, on the aforesaid continuous basis, the bags (30) located within the cargo box (24) to the inlet end (62) of the chute (60) as aforesaid.

According to an aspect of the invention, in the bag feeding step, a ram mechanism (50c) of the bag feeding means (50) mechanically slides along a longitudinal axis (“A”). The longitudinal axis (“A”) is defined by a floor surface (42) that extends in substantially transverse relation between the first end wall (26) and an opposed second end wall (28) of the cargo box. The ram mechanism (50c) slides in generally parallel relation to the floor surface (42) from a starting positon (FIG. 4A) adjacent the second end wall (28) to a final position (FIG. 4C) adjacent the first end wall (26). In this manner, the bags (30) stacked on the floor (42) of the cargo box (24) are pushed towards the inlet end (62) of the chute (60).

According to an aspect of the invention, in the bag feeding step, guide members (44) assist in guiding the bags (30) towards the inlet end (62) of the chute (60). The guide members (44) are mounted on the floor surface (42) adjacent the first end wall (26) in skewed relation to the longitudinal axis (“A”).

According to an aspect of the invention, the material processing step further includes a second stage (74) of using the material processing unit (70) to further process the composite material, before it reaches a blower unit (76) of the material processing unit (70). The blower unit (76) then feeds and delivers the composite material into the fluid stream (“B”) in fluid communication with said hose (32) as aforesaid.

According to an aspect of the invention, the commercial-grade method also includes a measuring step, substantially contemporaneous with the bag feeding step and/or the material processing step. In the measuring step, a loosefill insulation measuring means (80) is associated with the bag feeding means (50), the chute (60), the material processing unit (70), and/or the hose (32). In the measuring step, a loosefill insulation measuring means (80) is used for measuring the number of bags (30) of loosefill insulation material, and/or a volume of insulation from the bags (30), located within the cargo box (24) which are blown through the hose (32).

According to an aspect of the invention, the commercial-grade method also includes a separate enclosing step, before the bag feeding step and/or the material processing step. In the separate enclosing step, one or more working/moving parts and/or other sensitive components of the bag feeding means (50) and/or the material processing unit (70) are housed in a separate enclosure (90). The enclosure (90) is separately ventilated and/or cleanly sealed away from exposure to the loosefill insulation material.

Other advantages, features and characteristics of the present invention, as well as methods of operation and functions of the related elements of the structure, and the combination of parts and economies of manufacture, will become more apparent upon consideration of the following detailed description with reference to the accompanying figures, the latter of which are briefly described hereinbelow.

### BRIEF DESCRIPTION OF THE FIGURES

The novel features which are believed to be characteristic of the truck-mounted cargo box, kit, system, and method for installing loosefill blown insulation according to the present invention, as to their structure, organization, use and method of operation, together with further objectives and advantages thereof, will be better understood from the following figures in which one or more exemplary embodiments of the invention will now be illustrated by way of example. It is expressly understood, however, that the figures are for the purpose of illustration and description only, and are not intended as a definition of the limits of the invention. In the accompanying figures:

FIG. 1 is a top plan schematic view of a truck-mounted cargo box for installing loosefill blown insulation according to a first embodiment of the invention;

FIG. 2 is a right-side elevational schematic view of the cargo box of FIG. 1, shown in a raised configuration;

FIG. 3 is a rear sectional schematic view of a front end wall of the truck-mounted cargo box along section line 3-3 of FIGS. 1 and 2;

FIG. 4 is a right-side elevational schematic view of a truck-mounted cargo box for installing loosefill blown insulation according to a second embodiment of the invention;

FIG. 5A is a top plan schematic view of a truck-mounted cargo box for installing loosefill blown insulation according to a third embodiment of the invention, shown with a ram mechanism thereof in a starting position;

FIG. 5B is a top plan schematic view of the cargo box of FIG. 5A, shown with the ram mechanism in an intermediate position; and

FIG. 5C is a top plan schematic view of the cargo box of FIG. 5A, shown with the ram mechanism in a final position.

### DETAILED DESCRIPTION OF THE INVENTION

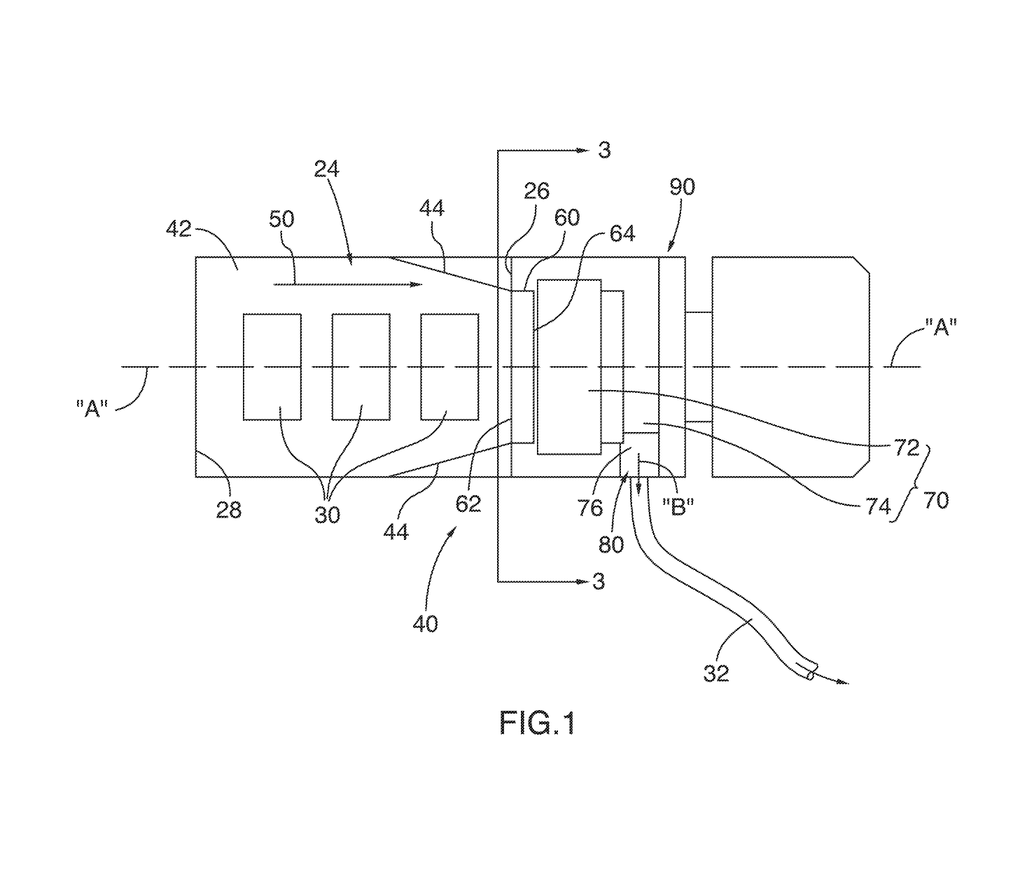

Now, with reference to accompanying FIGS. 1 to 5C, there is shown a commercial-grade system 40, housed in a cargo box mounted on a trailer 22 of a truck 20. The cargo box 24 preferably has longitudinally opposed front and rear end walls 26,28 and a floor surface 42 which extends between the front and rear end walls 26,28 in substantially transverse relation to thereby define a longitudinal axis (as generally indicated by axis line “A” in FIGS. 1 and 4-5C). Preferably, the cargo box 24 also has left and right side walls and a roof. The cargo box 24 preferably also has a loading door (not shown). Bags 30 filled with loosefill insulation material are loaded into the cargo box 24, preferably through the loading door.

The system 40 is for blowing the loosefill insulation material in the bags 30, through a hose 32, without first removing the insulation material from the bags 30. The system 40 includes a material processing unit 70, a chute 60 having an inlet end 62 positioned in the front end wall 26 of the cargo box 24, and a bag feeding means 50 associated with the cargo box 24 for mechanically moving the bags 30, located within the cargo box 24, to the inlet end 62 of the chute 60 on a continuous basis.

### Guide Members

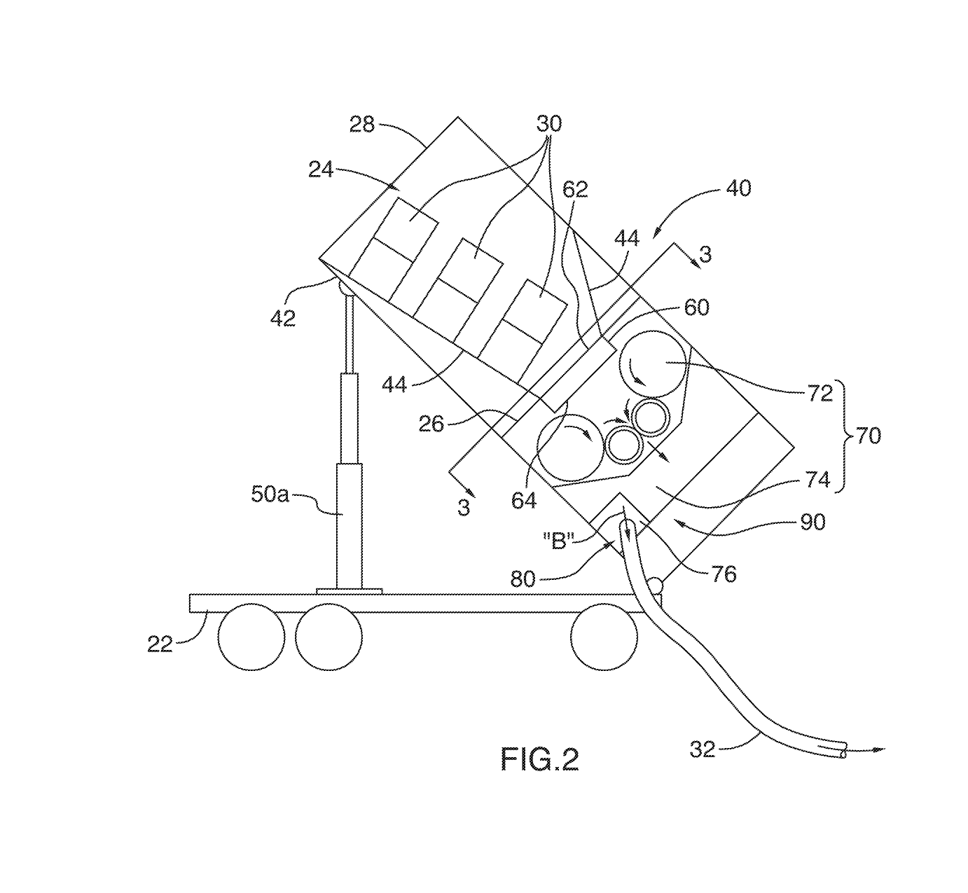

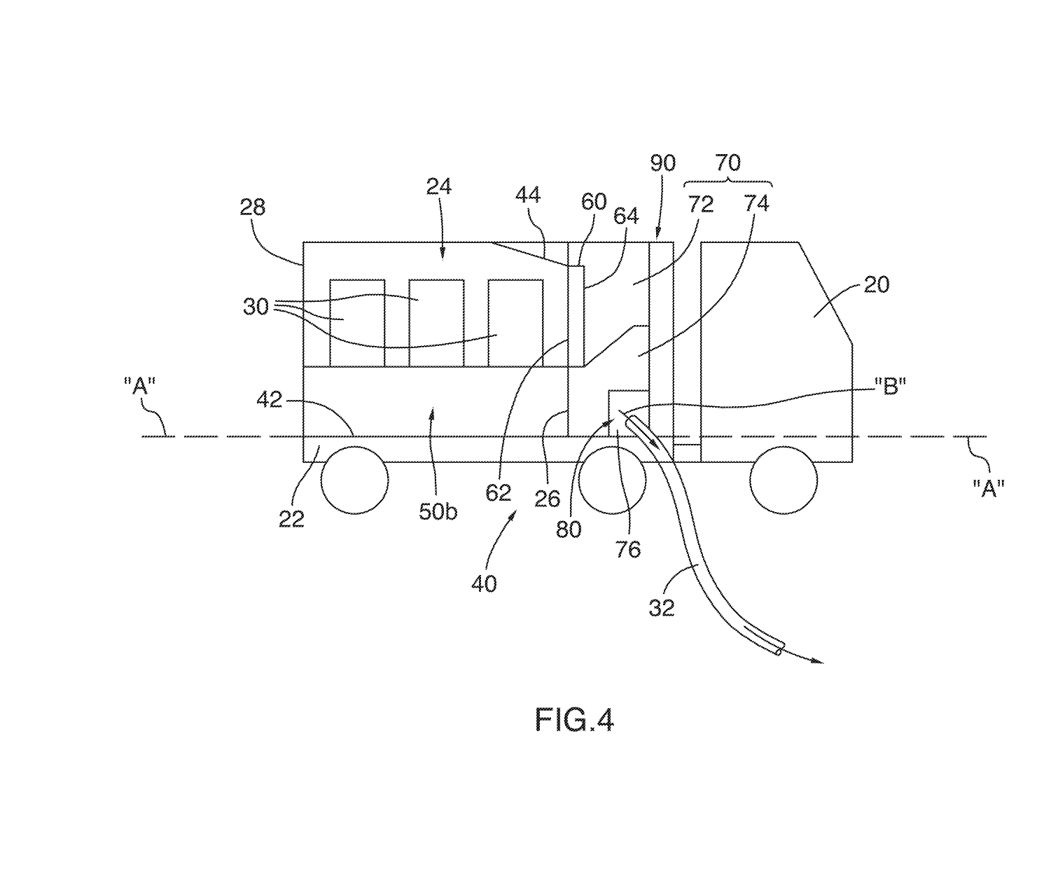

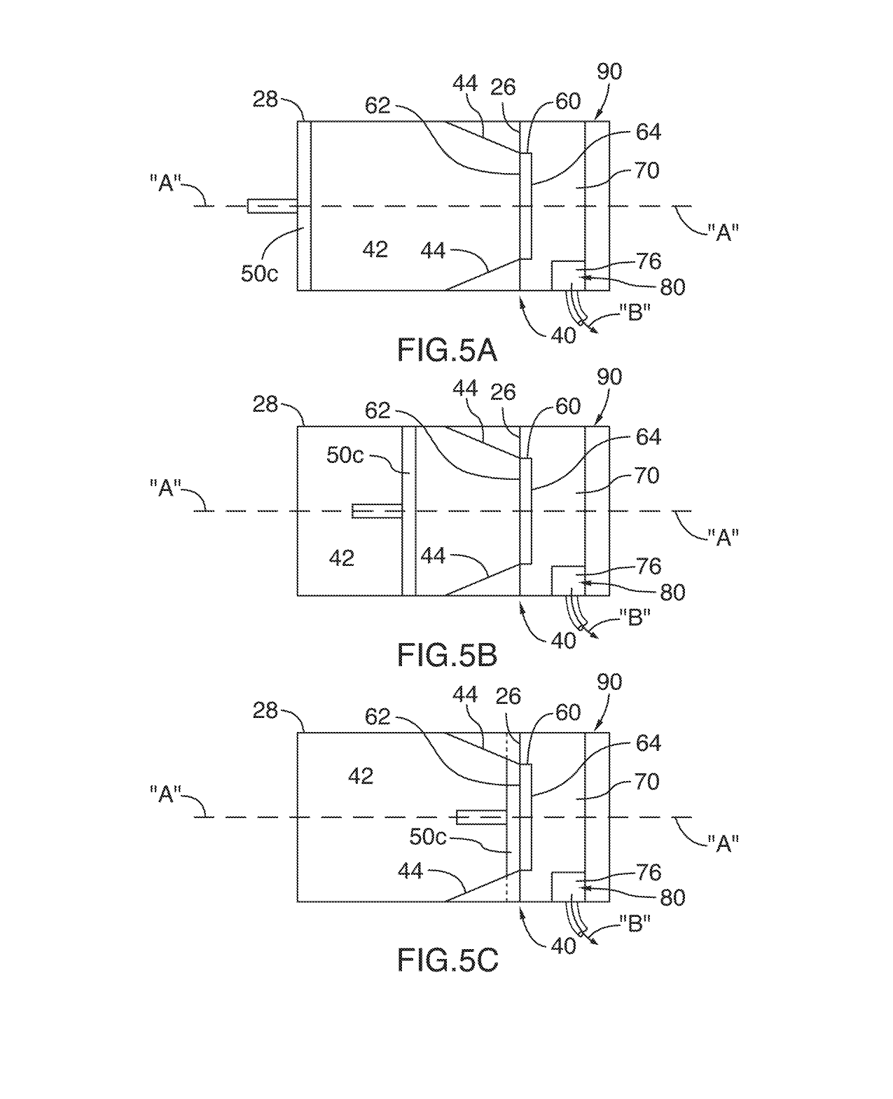

The system 40 preferably also includes guide members 44. As shown in FIG. 1 and in FIGS. 5A-5C, the guide members 44 preferably include side guide members 44 mounted on the floor surface 42 adjacent the front end wall 26 in skewed relation to the longitudinal axis (“A”) to assist in laterally guiding the filled bags 30 towards the inlet end 62 of the chute 60. As shown in FIG. 2, the guide members 44 may—in some embodiments of the system 40—also include a floor guide member 44 mounted on the floor surface 42 adjacent the front end wall 26, with the floor guide member 44 running the length of the floor surface 42 in skewed relation to the longitudinal axis (“A”) to further assist in guiding the filled bags 30 towards the inlet end 62 of the chute 60. Also, the guide members 44 may optionally—as shown in FIGS. 2 and 4—include a roof guide member 44 mounted on the roof of the cargo box 24 adjacent the front end wall 26 in skewed relation to the longitudinal axis (“A”) to additionally assist in guiding the filled bags 30 towards the inlet end 62 of the chute 60.

### Bag Feeding Means

FIGS. 2, 4 and 5A-5C schematically show various forms for the bag feeding means 50 according to three different embodiments of the invention. First, FIG. 2 schematically shows the bag feeding means 50 in the form of a dump-style lifting apparatus 50a. The dump-style lifting apparatus 50a is operatively connected to the cargo box 24, to lift the rear end 28 of the cargo box 24 higher than the front end 26, so as to move the bags 30 towards the inlet end 62 of the chute 60 under the influence of gravity. Further, the dump-style lifting apparatus 50a may preferably include a vibrating means (not shown) to shake and/or vibrate the cargo box 24. The vibrating means (not shown) may preferably help to move and cleanly dump the bags 30 and/or insulation material towards the inlet end 62 of the chute 60, to dislodge any of them that otherwise may become stuck and/or wedged (e.g., as a result of the cargo box 24 being tipped), and/or to afford faster dump times, more efficient dumping, increased operator safety, and/or lower labor costs.

Next, FIG. 4 schematically shows the bag feeding means 50 in the form of a moving floor apparatus or a conveyor belt 50b according to another embodiment of the invention. The moving floor apparatus or conveyor belt 50b is shown, schematically, in FIG. 4. An example of a prior art moving floor apparatus may be seen in a short video entitled “Naczepa ruchoma podloga BODEX z hydrauliczną windą zaladowczą” (which may be translated as “Moving floor trailer BODEX with hydraulic lift loading” and) which appears to have been published on 9 Aug. 2014 by Bodex (a manufacturer of semi-trailers located in Szczerców, Poland) and is accessible online, as of July 2016, via the following uniform resource locator (URL): https://www.youtube.com/watch?v=ovTMGbcGcIg In operation, the moving floor apparatus or conveyor belt 50b shown in FIG. 4 mechanically moves the bags 30 located within the cargo box 24 towards the inlet end 62 of the chute 60 on a continuous basis.

Additionally, FIGS. 5A to 5C schematically show the bag feeding means 50 in the form of a ram mechanism 50c according to another exemplary embodiment of the invention. The ram mechanism 50c mechanically slides along the longitudinal axis (“A”) in generally parallel relation to the floor surface 42, from a starting positon adjacent the rear end wall 28 (as shown in

FIG. 5A), through an intermediate positon (as shown in FIG. 5B), to a final position adjacent the front end wall 26 (as shown in FIG. 5C). In this manner, the ram mechanism 50c mechanically pushes the bags 30 stacked on the floor 42 of the cargo box 24 towards the inlet end 62 of the chute 60. As aforesaid, the cargo box 24 preferably has a loading door (not shown), through which the bags 30 filled with the loosefill insulation material preferably may be loaded into the cargo box 24, preferably through the loading door. According to the invention, the loading door (not shown) may be provided, inter alia, adjacent the rear end wall 28 of the cargo box 24 (as an integral part of, or along with, the ram mechanism 50c), and/or in one or more of the side walls and/or the roof of the cargo box 24.

### Front End Wall of the Cargo Box

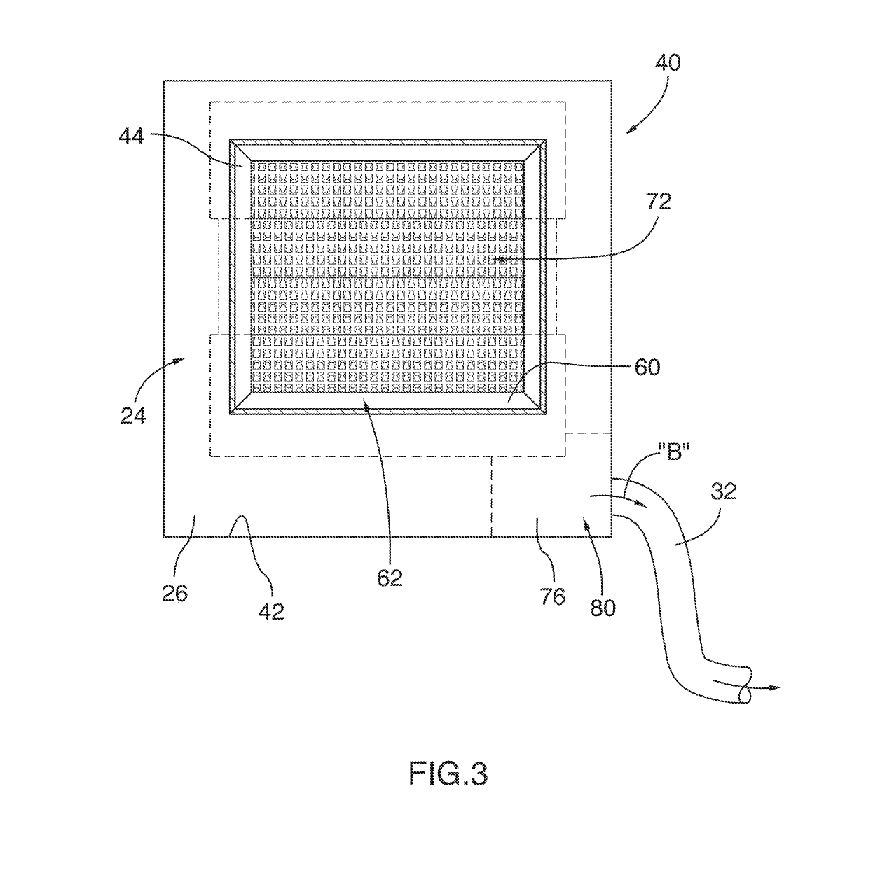

As aforesaid, the front end wall 26 of the cargo box 24 has the inlet end 62 of the chute 60 positioned therein, as may be best seen in FIG. 3. The guide members 44 help guide the bags 30 towards the inlet end 62. The inlet end 62 of the chute 60 is dimensioned and otherwise adapted to accept the bags 30 from the cargo box 24 through the front end wall 26. The chute 60 then directs the insulation filled bags 30 to an outlet end 64 thereof and towards the material processing unit 70.

### Material Processing Unit

The material processing unit 70 is adapted to receive the bags 30 filled with the loosefill insulation material from the outlet end 64 of the chute 60. As best seen in FIGS. 2 and 3, the material processing unit 70 includes a first processing stage 72, positioned adjacent to the outlet end 64 of the chute 60 in receiving relation thereto, in the form of a wood-chipper style or other industrial/commercial grade shredder 72. For example, as shown in FIGS. 2 and 3, the wood-chipper style or other industrial/commercial grade shredder 72 may be of a type that has a plurality of rotating drums with interdigitating rows of cutting teeth / blades extending therefrom (as shown in FIG. 3). Persons skilled in the art may appreciate, in view of the disclosures herein, that one or more prior art commercial grade wood-chippers may be suitable, with any appropriate modifications or alterations as may be required or desired, for use with and/or according to the invention including, for example, the model Drum Chipper TRH 280×650-4W offered by Holzmatic Engingeering GmbH (of Bozen, Italy) and/or one or more others in the prior art. The shredder 72 shreds both the bags 30 and the insulation material contained therein, together, into fine particles without first removing the insulation material from the bags 30, and without mechanical failure or interruption that otherwise might have been attributable to any shredding of bags filled with insulation material in the prior art.

The material processing unit 70 conditions both the shredded bags 30 and the insulation material, which was contained therein and released therefrom during the aforesaid shredding, as a composite material of substantially uniform consistency to a desired density.

In this respect, the material processing unit 70 includes a second stage 74 which further processes the composite material, to a preferred consistency, texture and/or density, before it reaches a blower unit 76. For example, the second stage may preferably include a suitable agitator or rotary-driven shaft or auger (equipped, e.g., with blades or teeth) and/or it may otherwise further shred, de-clump, pick apart or break up one or more clumps in the composite material—i.e., to process the composite material to the preferred consistency, texture and/or density before reaches the blower unit 76. The material processing unit 70 and the blower unit 76 are configured to feed and deliver the composite material into a fluid stream (as indicated generally by arrow “B” in FIGS. 1-5C) through and in fluid communication with the hose 32.

### Other Features

The system 40 preferably also includes a loosefill insulation measuring means 80—associated with the bag feeding means 50, the chute 60, the material processing unit 70, and/or the hose 32—for measuring the number of bags 30 of loosefill insulation material, and/or a volume of the composite material, which is blown through the hose 32. To continuously determine the amount of insulation and bags 30 being dispensed from the dispensing end of the hose 32 during operation, the measuring means 80 may be provided, for example, in whole or in part in the form of: a sluice gate and/or a throttle associated with the blower unit 76; a weighing arrangement associated with the bag feeding means 50; one or more optical sensors; and/or another quantitative determinator or gauge.

Working/moving parts and other sensitive components of the system 40 preferably may be housed in a separate enclosure 90 which, according to the invention, is separately ventilated and/or cleanly sealed away from exposure to the loosefill insulation material.

### Kit for Retrofitting a Cargo Box

Preferably, the system 40 may be offered as a kit for retrofitting an existing cargo box 24 that may be mounted on a truck 20 or a trailer 22. Skilled persons may appreciate, in view of the teachings and disclosures hereof, that use of such kit and an associated method of installing same could provide such a cargo box 24 with one or more of the aforesaid functionalities and/or advantages over the prior art.

### Methods of Use

According to the invention, the cargo box 24 and the system 40 may be used in accordance with a novel and inventive method that preferably includes a bag feeding step, a bag directing step, a material processing step, and a measuring step substantially contemporaneous with the bag feeding step and/or the material processing step.

The method may also preferably include a separate enclosing step, before the bag feeding step or the material processing step, wherein working/moving parts or other sensitive components of the bag feeding means 50 or the material processing unit 70 are housed in a separate enclosure 90 which is separately ventilated and cleanly sealed away from exposure to the loosefill insulation material.

Next, in the bag feeding step, the bag feeding means 50 is preferably used to mechanically move, on a continuous basis, the bags 30 located within the cargo box 24 to the inlet end 62 of the chute 60, which is positioned in the end wall 26 of the cargo box 24. The guide members 44 assist in guiding the bags 30 towards the inlet end 62 of the chute 60.

In the bag directing step, the chute 60 directs the bags 30, received from the cargo box (24) through the first end wall 26, to the outlet end 64 thereof and towards the material processing unit 70.

In the material processing step, the material processing unit 70 receives the bags of loosefill insulation material 30 from the outlet end 64 of the chute 60. The wood-chipper style or other industrial/commercial grade shredder 72 is used to together shred both the bags 30 and the insulation material contained therein, without first removing the insulation material from the bags 30. The material processing unit 70 additionally conditions both the shredded bags 30 and the loosefill insulation material, which was released therefrom during the aforesaid shredding, as a composite material of substantially uniform consistency to a desired density. The second stage 74 of the material processing unit 70 further processes the composite material, to a preferred consistency, texture and/or density, before it reaches the blower unit 76. The material processing unit 70 and the blower unit 76 then feed and deliver the composite material into the fluid stream (“B”) in fluid communication with the hose (32).

In the measuring step, the measuring means 80 is used to measure the number of bags 30 of loosefill insulation material, and/or a volume of the composite material, which is blown through the hose 32.

### CONCLUSION

The cargo-box mounted blowing wool distribution system (and method of use) according to the invention preferably offers high wool-shredding throughput for large-scale and regular commercial-grade usage by professional insulation contractors. According to the invention a cargo box 24 can be transported to the jobsite, full of loosefill insulation bags 30. At the jobsite, a single person—i.e., an installer situated adjacent to the building cavity—can remotely operate the system 40 according to the invention. No separate machine operator is required. During operation, full bags 30 of insulation material located within the cargo box 24 are automatically and mechanically fed into the shredder 72 on a continuous basis according to the invention, leaving the installer free to use the distribution hose adjacent the building cavity to install the insulation, without possibility of injury from any cutting mechanisms of the material processing unit 70 or its shredder 72. According to the invention, the shredder 72 and the material processing unit 70 are specifically adapted to automatically shred, process and condition the bags 30 together with the insulation material, without causing potential damage thereto, and without any interruptions or project delays due to mechanical failure which otherwise might have been associated with any shredding of bags together with insulation material in the prior art. Advantageously, according to the invention, the various working and moving parts and other sensitive components of the system 40 preferably may be separately ventilated and cleanly sealed away from exposure to the loosefill insulation material. Also, by metering the flow of the composite material, the installer can remotely count the bags 30 and measure the amount of composite material as its being blown into the insulation cavity according to the invention.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components, features, steps for others, with alternate configurations of components, features, steps). Although some of the components, relations, configurations, features and/or steps according to the invention are not specifically referenced in association with one another, they may be used, and/or adapted for use, in association therewith. All of the aforementioned, depicted and various structures, configurations, features, relationships, steps, utilities and the like may be, but are not necessarily, incorporated into and/or achieved by the invention. Any one or more of the aforementioned structures, configurations, features, relationships, steps, utilities and the like may be implemented in and/or by the invention, on their own, and/or without reference, regard or likewise implementation of any of the other aforementioned structures, configurations, features, relationships, steps, utilities and the like, in various permutations and combinations, as will be readily apparent to those skilled in the art, without departing from the pith, marrow, and spirit of the disclosed invention.

For example, in view of the teachings and disclosures herein, skilled persons may appreciate that alternate designs and/or embodiments of one or more smaller-scale, lighter-weight and/or DIY style machines (and/or methods of their use) may be possible, according to the invention, to obviate or mitigate one or more disadvantages and/or shortcomings, to meet or provide for one or more needs and/or advantages, and/or to achieve one or more objects. For example, according to the invention, a lighter-weight and/or DIY system may be provided or retrofitted with a wood-chipper style or other industrial/commercial grade shredder (e.g., of a type that has a plurality of rotating drums with interdigitating rows of cutting teeth/blades extending therefrom) to receive and shred bags (not shown) of insulation material that are larger than those commonly used with DIY machines, without first removing the insulation material from the larger bags, and without mechanical failure or interruption, thus preferably to offer high wool-shredding throughput. With the aforesaid larger bags (not shown) of insulation material, such a system might then enable use by a single person—i.e., an installer situated adjacent to the building cavity—who might initially load the larger bags into the machine, before remotely operating the system and using a distribution hose adjacent the building cavity to install the insulation. Likewise, other disadvantages or shortcomings associated with unrelated fields art may be obviated or mitigated, other needs or advantages may be met or provided for, and/or other objects may be achieved by other modifications or alterations according to the present invention.

Other modifications and alterations may be used in the design, manufacture, and/or implementation of other embodiments according to the present invention without departing from the spirit and scope of the invention, which is limited only by the following claims and the claims of any regular patent applications claiming priority herefrom.

### PARTS LIST/REFERENCE NUMERALS

The following reference numerals have been used in the preceding disclosure and in the drawings, to refer to each of the following parts:
20 Truck
22 Trailer
24 Cargo box
26 First (front) end wall
28 Second (rear) end wall
30 Bags of insulation material
32 Hose
40 System
42 Floor surface
44 Guide members
50 Bag feeding means
50a Dump-style lifting apparatus (FIG. 2)
50b Conveyor belt/moving floor apparatus (FIG. 4)
50c Ram mechanism (FIGS. 5A to 5C)
60 Chute
62 Inlet end
64 Outlet end
70 Material processing unit
72 First stage/wood-chipper style apparatus
74 Second stage/further processing apparatus
76 Blower unit
80 Measuring means
90 Separate Enclosure
“A” Longitudinal axis
“B” Airstream/Fluid stream
FIG. 5A Starting position of ram mechanism 50c
FIG. 5B Intermediate position of ram mechanism 50c
FIG. 5C Final position of ram mechanism 50c

1. A system (40) housed in a cargo box (24) mountable on a truck (20) or a trailer (22), for blowing loosefill insulation material in bags (30) through a hose (32), without first removing the insulation material from the bags (30), said system comprising: a chute (60) having an inlet end (62) positioned in an end wall (26) of the cargo box (24) mounted on the truck (20); bag feeding means (50) associated with the cargo box (24) for mechanically moving the bags (30) located within the cargo box (24) to the inlet end (62) of the chute (60) on a continuous basis; and a material processing unit (70) in the form of a wood-chipper style or other industrial/commercial grade shredder (72), for together shredding the bags (30) and the insulation material, without first removing the insulation material from the bags (30), and conditioning them both, as a composite material, to be fed into a fluid stream (“B”) through the hose (32).

2. A system (40) housed in a cargo box (24) mountable on a truck (20) or a trailer (22), with the cargo box (24) having first and second opposed end walls (26, 28), wherein the system (40) is for blowing loosefill insulation material in bags (30) located within the cargo box (24) through a hose (32) without first removing said insulation from said bag (30), said system (40) comprising:
a) a floor surface (42) extending between said first and second end walls (26, 28) in substantially transverse relation to thereby define a longitudinal axis (“A”);
b) a chute (60) having an inlet end (62) and outlet end (64), the inlet end (62) positioned in said first end wall (26) and being dimensioned and otherwise adapted to accept said bags (30) from said cargo box (24) for directing same through said first end wall (26) to a material processing unit (70);
c) bag feeding means (50) associated with the cargo box (24) for mechanically moving the bags (30) located within the cargo box (24) to the inlet end (62) of the chute (60) on a continuous basis; and
d) a material processing unit (70) being adapted to receive the bags of loosefill insulation material (30) from said intake chute (62);
wherein the material processing unit (70) comprises, as a first processing stage (72) positioned adjacent to the outlet end (64) of the chute (60) in receiving relation thereto, a wood-chipper style apparatus (72) or other industrial/commercial grade shredder, for together shredding the bags (30) and the insulation material into fine particles without first removing the insulation material from the bags (30), and without mechanical failure or interruption attributable to said shredding of the bags (30);
wherein the material processing unit (70) is further adapted to condition both the shredded bags (30) and the loosefill insulation material released from the bags (30) during said shredding as a composite material of substantially uniform consistency, to a desired density; and
wherein the material processing unit (70) is further configured to feed and deliver the composite material into a fluid stream (“B”) in fluid communication with said hose (32).

3. The system (40) according to claim 2, wherein the bag feeding means (50) comprises a dump-style lifting apparatus (50a) operatively connected to the cargo box (24), wherein the second end (28) of the cargo box (24) is lifted thereby higher than the first end (26) of the cargo box (24) so as to move the bags (30) towards the inlet end (62) of the chute (60) under the influence of gravity.

4. The system (40) according to claim 2, wherein the bag feeding means (50) comprises a moving floor apparatus or a conveyor belt (50b).

5. The system (40) according to claim 2, wherein the bag feeding means (50) comprises a ram mechanism (50c) that slides along the longitudinal axis (“A”) in generally parallel relation to the floor surface (42) from a starting positon (FIG. 4A) adjacent the second end wall (28) to a final position (FIG. 4C) adjacent the first end wall (26) so as to push the bags (30) stacked on the floor (42) of the cargo box (24) towards the inlet end (62) of the chute (60).

6. The system (40) according to claim 2, additionally comprising guide members (44) mounted on the floor surface (42) adjacent the first end wall (26) in skewed relation to the longitudinal axis (“A”) to assist in guiding the bag members (30) towards the inlet end (62) of the chute (60).

7. The system (40) according to claim 2, wherein the material processing unit (70) further comprises a second stage (74) for further processing of the composite material, before it reaches a blower unit (76) of the material processing unit (70) which feeds and delivers the composite material into the fluid stream (“B”) in fluid communication with said hose (32) as aforesaid.

8. The system (40) according to claim 2, further comprising a loosefill insulation measuring means (80), associated with the bag feeding means (50), the chute (60), the material processing unit (70), and/or the hose (32), for measuring the number of bags (30) of loosefill insulation material, and/or a volume of insulation from the bags (30), located within the cargo box (24) which are blown through the hose (32).

9. The system (40) according to claim 2, wherein one or more working/moving parts of the system (40), and/or other debris sensitive components of the system (40), are housed in a separate enclosure (90) of the system (40), wherein the enclosure (90) is separately ventilated and/or cleanly sealed away from exposure to the loosefill insulation material.

10. A cargo box (24) mounted on a truck (20) or a trailer (22) for use with bags filled with loosefill insulation material located within the cargo box (24), wherein the cargo box (24) comprises:
a) first and second opposed end walls (26, 28), and a floor surface (42) extending between said first and second end walls (26, 28) in substantially transverse relation to thereby define a longitudinal axis (“A”); and
b) a commercial-grade system (40) for blowing said loosefill insulation material in said bags (30) through a hose (32) without first removing said insulation from said bag (30), said commercial-grade system (40) comprising:
i) a chute (60) having an inlet end (62) and outlet end (64), the inlet end (62) positioned in said first end wall (26) and being dimensioned and otherwise adapted to accept said bags (30) for directing same through said first end wall (26) to a material processing unit (70);
ii) bag feeding means (50) for mechanically moving the bags (30) located within the cargo box (24) to the inlet end (62) of the chute (60) on a continuous basis; and
iii) a material processing unit (70) being adapted to receive the bags of loosefill insulation material (30) from said intake chute (62);
wherein the material processing unit (70) comprises, as a first processing stage (72) positioned adjacent to the outlet end (64) of the chute (60) in receiving relation thereto, a wood-chipper style apparatus (72) or other industrial/commercial grade shredder, for together shredding the bags (30) and the insulation material into fine particles without first removing the insulation material from the bags (30), and without mechanical failure or interruption attributable to said shredding of the bags (30);
wherein the material processing unit (70) is further adapted to condition them both—i.e., the shredded bags (30) and the loosefill insulation material released from the bags (30) during said shredding—as a composite material of substantially uniform consistency, to a desired density; and
wherein the material processing unit (70) is further configured to feed and deliver the composite material into a fluid stream (“B”) in fluid communication with said hose (32).

11. A method for blowing loosefill insulation material in bags (30), which are located within a cargo box (24) that is mounted on a truck (20) or a trailer (22), through a hose (32), without first removing the insulation material from the bags (30), wherein the commercial-grade method comprises the steps of:
a) a bag feeding step of using bag feeding means (50) associated with the cargo box (24) to mechanically move, on a continuous basis, the bags (30) located within the cargo box (24) to an inlet end (62) of a chute (60), with the inlet end (62) being positioned in a first end wall (26) of the cargo box (24) and being dimensioned and otherwise adapted to accept said bags (30) from said cargo box (24) through said first end wall (26);
b) a bag directing step of using the chute (60) to direct said bags (30), received from said cargo box (24) through said first end wall (26), to an outlet end (64) of the chute (60) and towards a material processing unit (70); and
c) a material processing step of using the material processing unit (70) to receive the bags of loosefill insulation material (30) from the outlet end (64) of the chute (62); and wherein the material processing step comprises:
i) a first processing stage of using a wood-chipper style apparatus (72) or other industrial/commercial grade shredder of the material processing unit (70), with the wood-chipper style apparatus (72) or other industrial/commercial grade shredder being positioned adjacent to the outlet end (64) of the chute (60) in receiving relation thereto, to together shred the bags (30) and the insulation material into fine particles, i.e., without first removing the insulation material from the bags (30), and without mechanical failure or interruption attributable to said shredding of the bags (30); and
wherein, in the material processing step, the material processing unit (70) additionally:
conditions both the shredded bags (30) and the loosefill insulation material released from the bags (30) during said shredding, as a composite material of substantially uniform consistency, to a desired density; and
feeds and delivers the composite material into a fluid stream (“B”) in fluid communication with said hose (32).

12. The method of claim 11 wherein, in the bag feeding step, a dump-style lifting apparatus (50a) of the bag feeding means (50) is operatively connected to the cargo box (24) and used to mechanically lift a second end (28) of the cargo box (24) higher than the first end (26), with the second end (28) being longitudinally opposed to the first end (26) of the cargo box (24), so as to move the bags (30) towards the inlet end (62) of the chute (60) under the influence of gravity.

13. The method of claim 11 wherein, in the bag feeding step, a moving floor apparatus or a conveyor belt (50b) of the bag feeding means (50) is associated with the cargo box (24) and used to mechanically move, on said continuous basis, the bags (30) located within the cargo box (24) to the inlet end (62) of the chute (60) as aforesaid.

14. The method of claim 11 wherein, in the bag feeding step, a ram mechanism (50c) of the bag feeding means (50) mechanically slides along a longitudinal axis (“A”), which is defined by a floor surface (42) that extends in substantially transverse relation between said first end wall (26) and an opposed second end wall (28) of the cargo box, in generally parallel relation to the floor surface (42) from a starting positon (FIG. 4A) adjacent the second end wall (28) to a final position (FIG. 4C) adjacent the first end wall (26) so as to push the bags (30) stacked on the floor (42) of the cargo box (24) towards the inlet end (62) of the chute (60).

15. The method of claim 11 wherein, in the bag feeding step, guide members (44) assist in guiding the bags (30) towards the inlet end (62) of the chute (60), with the guide members (44) being mounted on the floor surface (42) adjacent the first end wall (26) in skewed relation to the longitudinal axis (“A”).

16. The method of claim 11, wherein the material processing step further comprises a second stage (74) of using the material processing unit (70) to further process the composite material, before it reaches a blower unit (76) of the material processing unit (70) which feeds and delivers the composite material into the fluid stream (“B”) in fluid communication with said hose (32) as aforesaid.

17. The method of claim 11, further comprising a measuring step, substantially contemporaneous with the bag feeding step and/or the material processing step, of using a loosefill insulation measuring means (80), associated with the bag feeding means (50), the chute (60), the material processing unit (70), and/or the hose (32), for measuring the number of bags (30) of loosefill insulation material, and/or a volume of insulation from the bags (30), located within the cargo box (24) which are blown through the hose (32).

18. The method of claim 11, further comprising a separate enclosing step, before the bag feeding step and/or the material processing step, of housing one or more working/moving parts and/or other sensitive components of the bag feeding means (50) and/or the material processing unit (70) in a separate enclosure (90), with the enclosure (90) being separately ventilated and/or cleanly sealed away from exposure to the loosefill insulation material.

19. A kit for retrofitting a cargo box (24) with a system (40) according to claim 2.
